(19) United States
(12) Patent Application Publication
(10) Pub. No.: US 2004/0174362 A1
(43) Pub. Date: Sep. 9, 2004

(54) Deformable healer for removing CAD database connectivity gaps from free-form curves and surfaces

(76) Inventor: George Celniker, Austin, TX (US)

Correspondence Address: JENNER & BLOCK, LLP, ONE IBM PLAZA, CHICAGO, IL, 60611, US

(21) Appl. No.: 10/776,128

(22) Filed: Feb. 11, 2004

Related U.S. Application Data
(60) Provisional application No. 60/446,302, filed on Feb. 11, 2003.
(60) Provisional application No. 60/446,352, filed on Feb. 11, 2003.

(51) Int. Cl. G06T 11/20

(52) U.S. Cl. 345/441

(57) ABSTRACT

The invention is a method and computer application, implemented as a computer program, for modifying the shape of free-form Computer Aided Design (CAD) curves and surfaces to eliminate bad gap problems from CAD databases. The change of shape invention is based on an optimization algorithm that modifies a free-form shape to minimize its connectivity gaps while being constrained to minimize any changes in initial shape. The invention can be used to eliminate bad connectivity gaps, tangency gaps, curvature gaps, and gaps based on higher order differential properties. The invention can be used to modify any free-form curve or surface shape that is represented as a linear sum of basis functions. This class of functions includes but is not limited to B-splines, NURBS, and Hermite polynomials.

### CROSS-REFERENCE TO RELATED APPLICATIONS

This application claims priority from U.S. Provisional Patent Applications Serial No. 60/446,302, filed on Feb. 11, 2003, entitled “Interactive Healer For Finding And Removing Cad Database Errors And Data Inefficiencies” to Celniker, and Serial No. 60/446,352, filed on Feb. 11, 2003, entitled “Deformable Healer For Removing Cad Database Connectivity Gaps From Free-Form Curves And Surfaces” to Celniker, the contents of which are hereby incorporated by reference.

### FIELD OF THE INVENTION

The invention relates generally to computer-aided design (CAD) applications and to healing and interoperability applications that support transferring data between various CAD systems and specifically to modifying the shapes of free-form curves and surfaces contained in boundary representation (B-rep) solid models.

### BACKGROUND OF THE INVENTION

The invention relates to the modification of shape functions represented in CAD databases to remove gap errors that impair the databases' ability to be translated between CAD systems and to be exploited by downstream CAD database applications without changing the intent of the original shape design documented by the CAD database.

CAD solid models containing free-form surfaces are typically represented as a network of patches across seam boundaries where each patch is itself a piece-wise continuous function [Farm 1988]. Often times, the patches cannot exactly connect together along their boundaries. There are small differences in the position and small variations in the cross-tangent and cross-curvature values along the seams creating gaps. These discontinuities are inherent to the geometry representations required for free-form shapes. Typically, a CAD system will guarantee that these discontinuities will be limited to a specified tolerance value and it is now common to refer to these discontinuities as tolerances and managing the gaps between patches as the tolerancing problem.

Different CAD systems handle tolerances in different manners. Placing the tolerances of one CAD system on another often results in an unusable CAD model. The push for interoperability has been limited by a lack of an ability to explicitly manage free-form surface tolerances. Interoperability attempts at managing the tolerance problem have included finessing the issue by translating features rather than geometry [Rappaport 2003] and the use of common shared models [Bentley et al. 1998], and just ignoring the problem and translating the geometry directly via IGES, STEP, and specific point-to-point translators such as those marketed by Theorem Inc. However, features cannot generally represent free-form surfaces, and the many existing CAD systems and databases cannot take advantage of a common modeling approach. There is a need to translate free-form surfaces between CAD systems with a specified tolerance.

The need exists for a healing algorithm that will reduce the tolerances along the boundary of a free-form surface to a specified tolerance while minimizing any changes to its initial shape.

Mathematics and numerical methods for variational techniques for the interactive design of free-form shapes are known in the art. [Celniker 1992], [Celniker 1999] and [Celniker et al. 2002] apply variational techniques to the interactive design of free-form shapes but do not address the issue of enforcing boundary constraints that are not initially satisfied.

Enforcing constraints on geometry with non-variational approaches include the work of [Chyz 1985], [Gui 1993], [Lin 1981], [Pabon 1985], and [Rossignac 1988]. These approaches work with the parametric geometry representations such as line segments, planes, and conics, and do not extend to managing free-form surfaces. The theory of mathematical constraints is well known in the art. [Freidman I 1969], [Friedman II 1969], [Friedman III 1969].

### SUMMARY OF THE INVENTION

This invention solves the problem of healing gap errors between free-form curves and surfaces and their bounding edges and vertices within a B-rep solid model by deforming the free-form shape to more closely approximate the locations of its bounding geometry while minimizing any changes to the original shape.

One aspect of the invention relates to an iterative method for refining a free-form shape consisting of a sequence of cycles where each cycle consists of checking the shape's current gap sizes and if larger than a specified tolerance optimizing that shape using the shape's current degrees of freedom to minimize the shape's gap vectors while also minimizing the shape's deviation from its initial position, and if the gaps remain larger than the given tolerance introducing new degrees of freedom to the shape by subdividing the shape's elements, and continuing this cycle until all gaps sizes are less than the given tolerance.

In a further aspect of the invention the optimization problem is stated as a variational problem with a cost function including a weighted penalty for changes in the free-form shape's initial position, stretch, and bending states, and a sum of weighted penalties for each gap distance. In alternative embodiments, the cost function includes a set of point constraints. The solution of the optimization problem finds the one shape out of all possible shapes that reduces the shape's gap sizes while minimizing any change to its original shape.

A further aspect of the invention relates to a heuristic method to refine the shape representation by choosing where to subdivide the shape elements based on the locations of gaps that exceed the given tolerance size.

A further aspect of the invention is a method for defining and finding a shape's gap vectors.

Another aspect of the invention relates to a method, called heal face-to-neighbors, for applying the curve and surface shape healing methods in a systematic manner to heal a target free-form face within a CAD B-rep solid model to its neighbor faces. The method consisting of partitioning all the bounding edges of a target free-form surface into one of two groups: constrained or regenerated, and healing each constrained edge to its neighbor face, then healing the target face to its bounding vertices and constrained edges, and finally reconstructing all the regenerated edges with surface-surface intersections to form a free-form face in a solid model that has no gaps to any of it neighbor faces larger than a given tolerance.

### BRIEF DESCRIPTION OF DRAWINGS

FIG. 1 is a flow chart illustrating the iterative application of the Heal-face-to-neighbors method to all the free-form surface gap problems within a single CAD database.

FIG. 2 is a flow chart illustrating the steps of the Heal-face-to-neighbors method.

FIG. 3 is a flow chart illustrating the steps of the heal-edge-to-face Method.

FIG. 4 is a flow chart illustrating the deformable curve healing method.

FIG. 5 is a flow chart illustrating the deformable surface healing method.

FIGS. 6a-b illustrates a CAD database before and after the heal-face-to-neighbors method is applied.

### DESCRIPTION OF EMBODIMENTS OF THE INVENTION

Deformable healing presents algorithms for healing errors in a B-rep CAD model that will reduce the tolerances along the boundary of a free-form surface to a specified tolerance while minimizing any changes to its initial shape. CAD models are produced by CAD systems such as CATIA, PRO-e, ACIS, or other CAD systems. The process of deformable healing states the tolerance problem as a variational optimization problem and solves it in a solid modeling context where changes to the geometry of faces, edges, and vertices have to be coordinated to preserve their geometric relationships. This coordination requires the extension of the deformable healing algorithm to free-form curves in which the tolerances between a curve and a surface are minimized while minimizing the change in the curve's original shape. The process of deformable healing uses the mathematics and numerical methods disclosed in U.S. Pat. No. 6,369,815 to Celniker et al [Celniker et al], the contents of which are herein incorporated by reference.

In one embodiment of the invention, the invention features an iterative heal-free-form-surfaces method, described in more detail below, which systematically removes or reduces to a specified tolerance all free-form gap problems from a CAD database by applying the heal-face-to-neighbors method described below to every free-form surface in a CAD database with bad gap problems.

The heal-face-to-neighbors method, described in more detail below, removes or reduces to a specified tolerance all the free-form gap problems associated with one free-form face in a solid modeling CAD database. It does this by systematically applying a heal vertex to neighbor method to each vertex connected to the face, applying a heal-edge-to-face method to every edge connected to the face, and finally by applying a deformable surface healing method, described in more detail below, to the surface itself.

The heal-edge-to-face method, described in more detail below, removes or reduces to a specified tolerance all the free-form gap problems associated with one free-form curve in a solid modeling CAD database. It does this by applying a deformable curve healing method to the curve itself. In this aspect the invention uses the method outlined below to heal the boundary of a CAD database face to its neighbors.

1. Moving vertices,

2. Heal-edge-to-face,

3. Deformable surface healing,

4. Rebuild edge by re-intersecting two surfaces, and

5. Rebuild vertex by re-intersecting faces.

The heal-face-to-neighbors aspect of the invention can enforce G0, G1, or G2 continuity between one face and its neighboring faces.

The deformable curve healing method described in more detail below minimizes the gaps between a curve and a target face and interpolates a set of target point locations while minimizing any change to the curve's initial shape. It does this by stating and solving a minimization problem to compute a new shape for the curve.

The deformable surface healing method described in more detail below minimizes the gaps between a surface and a set of target curves and interpolates a set of target point locations while minimizing any change to the surface's initial shape. It does this by stating and solving a minimization problem to compute a new shape for the surface.

Although the embodiment of the invention shown in FIG. 1 uses all of the methods described herein, alternative embodiments only use one or some of the specified methods to perform specific healing operations. In addition, alternative embodiments of the present invention can be used to heal analytic surfaces instead of free-form surfaces by converting the analytic surfaces to free-form surfaces and then applying the healing methods of the present invention.

Heal-Free-Form-Surfaces

An embodiment of the heal-free-form-surfaces method for healing all gap problems for all free-form surfaces in a CAD database is shown in FIG. 1. The method starts by identifying whether the database contains any free-form faces that have not yet been healed (2).

If more free-form faces need to be healed, the next face is selected (4). Any bad connectivity gaps on that face are fixed by applying the heal-face-to-neighbors method (6) described in more detail below. Vertices and edges that are modified by the heal-face-to-neighbors method are marked (8). On subsequent iterations the heal-face-to-neighbors method skips those edges and vertices that have already been healed.

The method repeats the steps of the method until all the free-form faces in the database have been visited.

Heal-Face-To-Neighbors

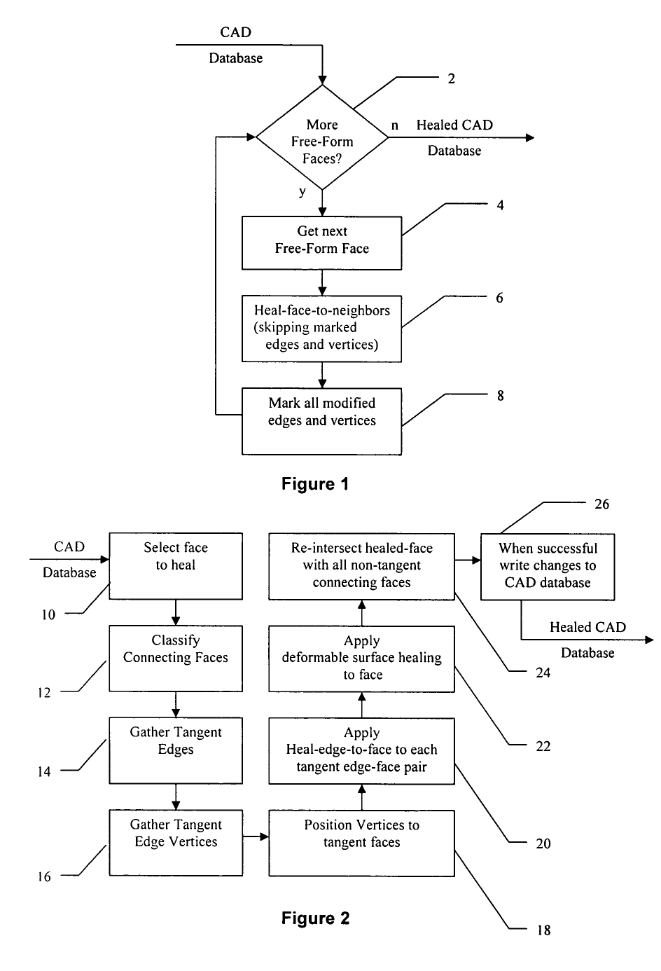

An embodiment of the method of heal-face-to-neighbors is shown in FIG. 2. Its purpose is to modify a CAD database to remove any gap problems between a free-form face and all of its neighbors. The first step of the method is to select the face to be healed (10). The selection can be done interactively by a user or automatically as part of a larger healing function.

Once the face is selected all of its connecting edges are classified as tangent or non-tangent (12). A tangent edge connects two faces in a CAD database that are tangent to one another along the length of the curve. A non-tangent edge connects two faces that have no points of tangency along the length of the curves. Edges with both tangent and non-tangent points are subdivided into edges that are cleanly tangent or non-tangent. The test for tangency is based on a geometric test of matching pairs of surface normal vectors sampled along the length of the edge on both connecting faces. The face that connects to the selected face through a tangent edge is called a tangent face.

All end-point vertices of the tangent edges are gathered (16). Each vertex location is checked to see that it lies on all the faces connected to the selected face at that vertex. If it does not, the location of the vertex is placed at the best possible place with respect to the connecting faces while minimizing its move (18). The best possible place is the intersection of the connecting faces if it exists. Otherwise it is the geometric average of projections to the faces and face intersections that is closest to the original point's position.

Once the end-point vertex locations are selected, each tangent edge is forced to lie on its tangent face by the heal-edge-to-face method described below using the end-point locations as point constraints and the tangent face's surface shape as the target surface shape (20).

After all the tangent edges are healed to their tangent faces, the shape of the select face's surface is modified by the deformable surface healing method described below using all the end-point locations as point constraints, the tangent edges as given curves, and the cross-tangent values sampled from the tangent faces along the length of the tangent curves as the given cross-tangent values (22).

The shape of every non-tangent edge is recomputed by intersecting the healed surface's shape with each non-tangent face (24). The reintersection not only computes the non-tangent edge's new shape but also the applicable end-point vertex locations.

When the method is successful, the CAD database is modified by replacing the selected face's surface with the healed surface shape, replacing all the connecting edge's shapes with the newly computed edge shapes, and replacing all the connecting edges end-point vertex locations with the newly computed vertex locations (26).

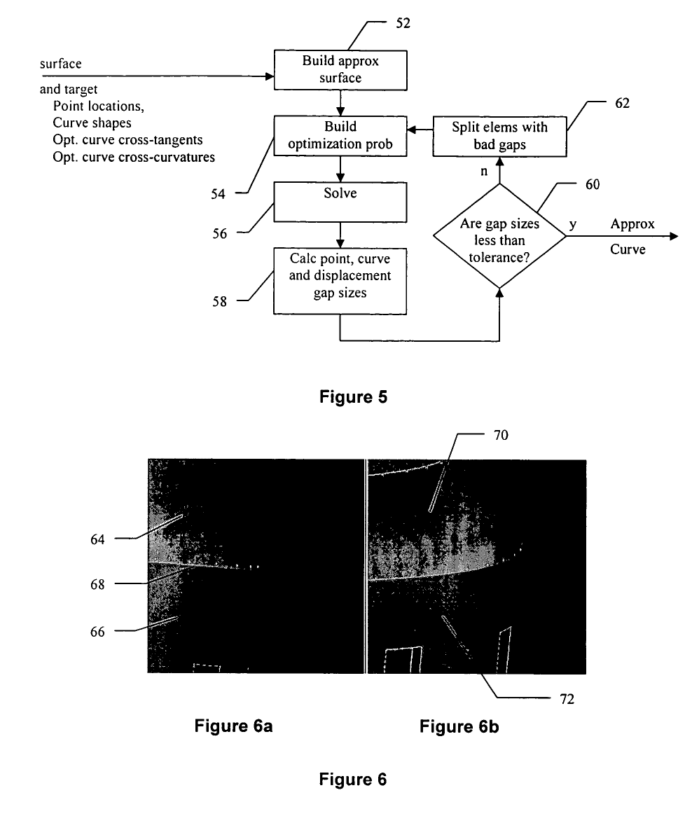

FIG. 6 shows an example of the operation of the heal-face-to-neighbors method for a CAD model. FIG. 6a shows the profile of a gap error between a B-spline surface 64 and a cylinder surface 66. The two surfaces are intended to be tangent along their connecting edge 68. The gap error can be seen as the overhang of surface 64 compared to surface 66. The heal-face-to-neighbors method is applied to the surface 64 and the result is shown in FIG. 6b. The B-spline surface has been replaced by the new surface 70 that is now tangent to the original cylindrical surface 72 while approximating the original B-spline surface shape shown in 64.

Heal-Edge-To-Face

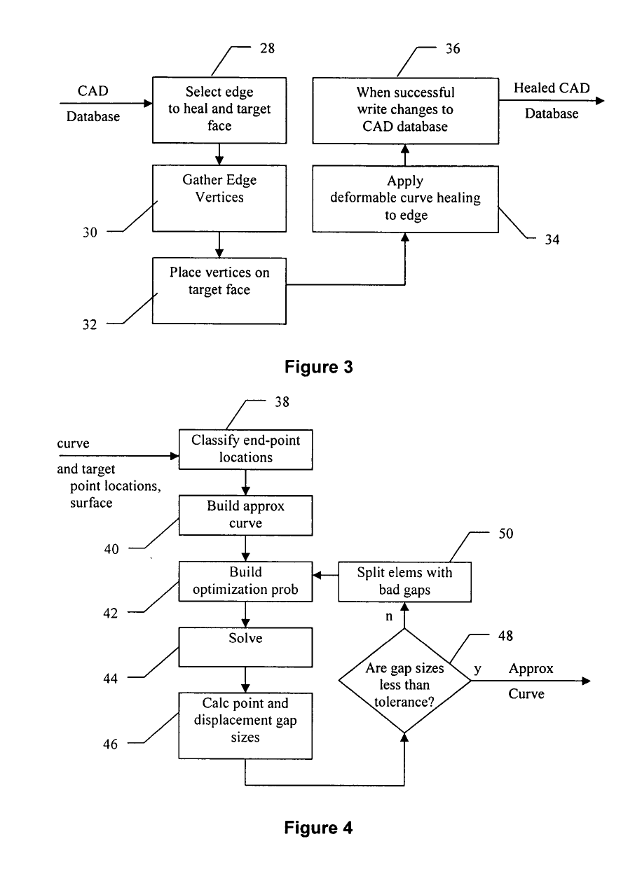

An embodiment of the method of heal-edge-to-face is shown in FIG. 3. Its purpose is to modify a CAD database to remove an edge to face bad gap problem. The first step of the method is to select the edge to modify and the face that the edge is to approximate (28). This selection process can be done interactively by an end user or automatically as part of a larger healing function.

The selected edge is used to gather the edge's end-point vertices (30). The locations of the end-point vertices are checked against the shape of the target face. When the vertices are not on the face, new locations are computed for them (32) by projecting the vertex locations onto the face. The vertices can be labeled to force skipping this step.

The shape of the edge is modified by the deformable curve healing method, described in more detail below, using the end-point locations as curve point constraints and the shape of the selected face as the target surface shape.

When the deformable curve healing method is successful, the CAD database is modified replacing the original end-point vertex locations with the new computed locations and replacing the edge's curve shape with the output curve shape computed by the deformable curve healing method (36).

Deformable Curve Healing

An embodiment of the method of deformable curve healing is illustrated in FIG. 4. Its purpose is to build a new curve description that approximates the shape of a given curve representation while interpolating a set of given point locations. Alternative embodiments build a new curve description approximating the shape of a given surface.

The method's first step is to classify the input point locations to see if any of those locations should be used as end-point locations for the curve (38). The classification is based on the distance of the closest specified location to the current curve end-point locations. When the specified locations are close to the end-point they are used as the target end-point location. When no point locations are specified near the current curve end-point location, the input curve's end-point location is used as the target end-point location.

A new piece of geometry, the approximating curve shape, is created (40). The underlying representation type for the approximating curve may be different than the input curve type. The approximate curve shape is the solution to an optimization problem that forces the approximating curve to interpolate the input curve's end-points while minimizing the variation between the curve's and the approximating curves positions and tangent values. This allows the method to be applied to any CAD curve representation while producing any type CAD curve representation as output. Additionally this allows the method to remove any over sampling and parameterization errors that may be contained within the input curve's representation.

The next step of the method builds an optimization problem with constraints, described in more detail below (42). When solved, the optimization problem forces the approximate curve to interpolate the specified point locations and the selected curve end-point locations and minimize the displacement from the original curve shape (44). Alternative embodiments minimize the displacement from an optionally supplied surface shape. The mathematical description of the optimization problem follows in the next sub-section.

After solving the optimization problem, the approximating curve is analyzed to determine the quality of the solution. Point gap sizes are computed as the distance between the approximating curve and the specified point location (46). The displacement gap size is the maximum gap size between the approximating curve and the curve's original shape or the maximum gap size between the approximating curve and the optional surface shape when the optional surface shape is specified.

The point and displacement gap sizes are analyzed to determine whether all gap sizes are below a specified tolerance value (48). If all point and displacement gap sizes are below the tolerance value, the process is finished and the output of the method is the newly created and formed approximating curve shape. Often times the approximate shape will not meet the gap tolerance requirement. In all cases the cause of this failure is having too few degrees of freedom in the approximating curve's underlying representation. When the gap sizes fail the tolerance test, the method inserts new degrees of freedom into the approximating curve's representation by splitting in half the elements of the curve that have bad gap values (50). The modified approximating curve representation is then used to recreate the optimization problem and repeat the steps of the method (42). The method continues to iterate until the gap size tolerance test (48) is passed.

Deformable Curve Healing Optimization Problem

The steps of creating the approximate curve shape (40) and building the optimization problem (42) are performed as follows. Curve shape is represented by a parametric function as,

c(s)=[x(s)y(s)z(s)]^{T}, sε[a b]⊂R Equation 1

Where c is the curve shape, s is the curve's domain space variable bounded by the values a and b, and x, y, z are the 3 space coordinate functions for C. We model an approximation to the curve shape c with the approximate curve shape w(s). We limit the coordinate functions for w to be of the form,

f(s)=Σfᵢφᵢ(s), sε[a b]⊂R. Equation 2

Where fᵢ is a scalar weight on the basis function, φᵢ(s). The optimization problem that is built and solved in 42 and 44 minimizes the cost function,

$$\begin{matrix}{C}_{curve} = {\int }_{σ}^{} ( {α ( \dot{c} - \dot{w} )}^{2} + {β ( \ddot{c} - \ddot{w} )}^{2} + {γ ( c - w )}^{2} ) ⅆ σ - \\ {\sum }_{i}^{} {λ}_{i} ( w ( {s}_{i} ) - {w}_{i}^{0} )\end{matrix} \qquad Equation 3$$

Where λᵢ are lambda variables for the point constraints and w(sᵢ) are the points on the approximating curve being forced to interpolate the specified target points, wᵢ⁰. The curve locations, sᵢ, are selected by projecting the target points to their nearest locations on the curve. The α, β, and γ gains may be varied to tune the quality of the approximation curve.

When building an approximate curve w that modifies a curve shape to interpolate a set of points while minimizing variations from its initial shape as in 40, the function c(s) is the original input curve. When building an approximation curve that approximates a given surface, c(s) is computed as the projection of the approximate curve points defined by the last iteration of the method onto the given surface.

Deformable Surface Healing

An embodiment of the method of deformable surface healing is shown in FIG. 5. Its purpose is to build a new surface description that approximates the shape of a given surface representation while interpolating a set of given point locations and approximating a set of given curve shapes. Optionally the method can also force the surface to approximate the cross-tangent or the cross-tangent and cross-curvature values along the length of the curve.

The method's first step is to build a new piece of geometry, the approximating surface (52). The underlying representation type for the approximating surface may be different than the input surface type. The approximate surface shape is the solution to an optimization problem that forces the approximate surface to interpolate the corner points of the input surface while minimizing variations in the surface's position and tangent values. This allows the method to be applied to any CAD surface representation while producing any type CAD surface representation as output. Additionally this allows the method to remove any over sampling and parameterization errors that may be contained within the input surface's representation. For performance reasons, building the approximate surface may be skipped.

The next step of the method builds an optimization problem with constraints, described in more detail below (54). The optimization problem is then solved (56). When solved, the optimization problem forces the approximate surface to:

(i) interpolate the specified point locations,

(ii) minimize displacements between the approximate surface and the specified curve shapes,

(iii) optionally minimize the variation between the specified cross-tangent values and the approximate surface's cross-tangent values along the length of the given curves,

(iv) or optionally minimize the variation between the specified cross-tangent and cross-curvature values and the approximate surface's cross-tangent and cross-curvature values along the length of the given curves, and

(v) minimize the variation in the approximate surfaces position and tangent values from the input surface's position and tangent values.

When building the optimization problem for the first time, the approximation surface's underlying representation is sub-divided to ensure that no more than one point-constraint is located in any one element.

After solving the optimization problem, the approximating surface is analyzed to determine the quality of the solution (58). Point gap sizes are computed as the distance between the approximating surface and the specified point location. Curve gap sizes are defined as the maximum gap size along the length of a given curve and the approximating surface. The displacement gap size is the maximum gap size between the approximating surface and the surface's original shape.

The point, curve, and displacement gap sizes are analyzed to determine whether all gap sizes are below a specified tolerance value (60). If all point, curve and displacement gap sizes are below the specified tolerance level, the process is finished and the output of the method is the newly created and formed approximating surface shape. Often times the approximate shape will not meet the gap tolerance requirements. In all cases the cause of this failure is having too few degrees of freedom in the approximating surface's underlying representation. When the gap sizes fail the tolerance test, the method inserts new degrees of freedom into the approximating surface's representation by splitting in half the elements of the surface that have bad gap values (62). The modified approximating surface representation is then used to recreate the optimization problem (54) and the steps of the method are repeated. The method continues to iterate until the gap size tolerance test (60) is passed.

Deformable Surface Healing Optimization Problem

The steps of creating the approximating surface (52) and building the optimization problem (56) are performed as follows. Surface shape is represented by a parametric function as,

s(u,v)=[x(u,v)y(u,v)z(u,v)]^{T}, uε[ab]⊂R, vε[cd]⊂R Equation 4

Where s is the surface shape, u and v are the surface's domain space variables bounded by the values a, b, c and d, and x, y, z are the 3 space coordinate functions for s. We model an approximation to the surface shape s with the approximate surface shape w(u,v). We limit the coordinate functions for w to be of the form,

f(u,v)=Σfᵢφᵢ(u,v), uε[ab]⊂R, vε[cd]⊂R. Equation 5

Where fᵢ is a scalar weight on the basis function, φᵢ(u,v).

The optimization problem that is built and solved in 54 and 56 minimizes the cost function,

$$\begin{matrix}\begin{matrix}{C}_{surface} = {\int }_{σ}^{} ( {\dot{Q}}^{T} \overline{α} \dot{Q} + {\ddot{Q}}^{T} \overline{β} \ddot{Q} + {γQ}^{2} ) ⅆ σ - \\ {\sum }_{i} {λ}_{i} ( w ( {u}_{i} , {v}_{i} ) - {w}_{i}^{0} ) + \\ {\sum }_{i} {k}_{curvegap} {\int }_{σ}^{} {( w ( {c}_{i}^{s} ( s ) ) - {c}_{i} ( s ) )}^{2} ⅆ s + \\ {\sum }_{i} {k}_{cross \text{-} tangent} {\int }_{σ}^{} {( {w}_{n} ( {c}_{i}^{s} ( s ) ) - {w}_{{n}_{i}} ( s ) )}^{2} ⅆ s + \\ {\sum }_{i} {k}_{cross \text{-} curvature} {\int }_{σ}^{} {( {w}_{nn} ( {c}_{i}^{s} ( s ) ) - {w}_{{nn}_{i}} ( s ) )}^{2} ⅆ s\end{matrix} & Equation 6 \\ Where Q = ( w - s ) , \dot{Q} = [ \begin{matrix}{q}_{u} \\ {q}_{v}\end{matrix} ] , \ddot{Q} = [ \begin{matrix}{q}_{uu} \\ {q}_{vv} \\ {q}_{vu}\end{matrix} ] . and \overline{α} = [ \begin{matrix}{α}_{11} & {α}_{12} \\ {α}_{21} & {α}_{22}\end{matrix} ] \overline{β} = [ \begin{matrix}{β}_{11} & & \\ & {β}_{22} & \\ & & {β}_{12}\end{matrix} ] . & Equation 7\end{matrix}$$

Where λᵢ are lambda variables for the point constraints and w(uᵢ,vᵢ) are the points on the surface selected to interpolate the given set of input points, wᵢ⁰. cᵢ(s) are the specified curve shapes, cᵢ^{s}(s) are the parametric projections of the cᵢ(s) curves onto the input surface, and wₙᵢ and wₙₙᵢ are the optional target cross-tangent first and second derivative values measured along the given cᵢ(s) curves. The values k_{curve gap}, k_{cross-tangent}, and k_{cross-curvature} are gain parameters, which can be adjusted to vary the solutions response to conflicting target values. The surface locations, (uᵢ,vᵢ), are selected by projecting the target points to their nearest locations on the surface. The α, β, and γ gains may be varied to tune the quality of the approximation surface.

Implementation

The invention may be implemented in hardware or software, or a combination of both. However, preferably, the invention is implemented in computer programs executing on programmable computers. Each program is preferably implemented in a high level language (such as C++, Java, or Lisp) to communicate with a computer system. However, the programs can be implemented in assembly or machine language, if desired. In any case the language may be compiled or interpreted, procedural or symbolic.

Each such computer program is preferably stored on a storage media or device (e.g., ROM or magnetic/optical disk or diskette) readable by a general or special purpose programmable computer, for configuring and operating the computer when the storage media or device is read by the computer to perform the procedures described herein. The inventive system may also be considered to be implemented as a computer-readable storage medium, configured with a computer program, where the storage medium so configured causes a computer to operate in a specific and predefined manner to perform the functions described herein.

The foregoing disclosure of embodiments of the present invention has been presented for purposes of illustration and description. It is not intended to be exhaustive or to limit the invention to the precise forms disclosed. Many variations and modifications of the embodiments described herein will be obvious to one of ordinary skill in the art in light of the above disclosures. The scope of the invention is to be defined only by the claims appended hereto, and by their equivalents.

What is claimed is:

1. A method for fixing problems in a CAD database having faces, edges and vertices, comprising:
adjusting the shape of at least one face, the shapes of each edge connected to said face, and positions of each vertex connected to said face to reduce to a specified tolerance the gap errors, cross-tangency tolerances, and cross-curvature tolerances associated with said face.

2. The method as claimed in claim 1 further comprising the step of iteratively adjusting the shape of a plurality of free-form faces in the CAD database, the shape of each edge connected to each face and the position of each vertex connected to said face to eliminate all gap errors associated with said plurality of faces.

3. The method as claimed in claim 1 where the gap, cross-tangent, and cross-curvature tolerances are computed by comparing surface evaluations taken at sample points on the shapes being adjusted and those points on neighboring faces nearest to the sample points.

4. The method as claimed in claim 1 where said face is an analytic face, further comprising the step of converting said analytic face into a free-form face before it is deformed.

5. A method for fixing problems in a CAD database having faces, edges and vertices, comprising:
adjusting the shape of an edge to eliminate or reduce to a specified tolerance the gap errors between said edge and a face connected to said edge and the gap errors between said edge and a plurality of vertices connected to said edge.

6. The method as claimed in claim 5, where the edge is an analytic edge, further comprising the step of converting the analytic edge into a free-form edge before it is deformed.

7. A method for fixing problems in a CAD database having curves and surfaces, comprising:
modifying a curve by
finding a modified curve shape that interpolates a set of point locations and minimizes the gap errors between said curve and a surface connected to said curve while minimizing deviations from the original shape face of said curve where the gap errors are expressed as constraints that must be satisfied or minimized; and
applying said modified curve shape to said curve.

8. The method as claimed in claim 7 where the shapes are represented as B-splines.

9. The method as claimed in claim 7 where the shapes are represented as NURBs.

10. A method for fixing problems in a CAD database having curves and surfaces, comprising:
modifying a surface by
finding a modified surface shape that interpolates a set of point locations, minimizes the gap errors between said surface and a set of curves connected to said surface, approximates the cross-tangent values for every point along each curve in said set of curves, and approximates the cross-curvature values for every point along each curve in said set of curves while minimizing deviations from the original shape face of said surface where the gap errors, cross-tangency tolerances, and cross-curvature tolerances are expressed as constraints that must be satisfied or minimized; and
applying said modified surface shape to said surface.

11. The method as claimed in claim 10 where the shapes are represented as B-splines.

12. The method as claimed in claim 10 where the shapes are represented as NURBs.
